(19) United States
(12) Patent Application Publication
(10) Pub. No.: US 2017/0284720 A1
(43) Pub. Date: Oct. 5, 2017

(54) SYSTEM AND METHOD FOR REMOTELY DETERMINING LOCAL OPERATING ENVIRONMENT OF A REFRIGERANT CONDENSER UNIT

(71) Applicant: Palo Alto Research Center Incorporated, Palo Alto, CA (US)

(72) Inventors: Victor Liu, Mountain View, CA (US); Sylvia Joan Smullin, Menlo Park, CA (US)

(21) Appl. No.: 15/087,367

(22) Filed: Mar. 31, 2016

(51) Int. Cl. F25B 49/02; F24F 11/00; G08B 21/18; G06N 5/04

(52) U.S. Cl. CPC F25B 49/027; G06N 5/04; F24F 11/0086; F24F 11/006; G08B 21/18; F25B 2700/15; F24F 2011/0058; F24F 2011/0061; F24F 2011/0091; F24F 2011/0047

(57) ABSTRACT

A system is configured to remotely determine characteristics of a local operating environment of an outdoor condenser unit. The system includes a detector configured to sample power consumption of the condenser unit to obtain a sampled power consumption time series. An analyzer receives the sampled time series of the detector and determines characteristics of a local operating environment of the condenser unit from the power consumption time series. The analyzer generates an output that includes information about the local operating environment.

### TECHNICAL FIELD

This disclosure generally involves approaches for determining an operating environment of a condenser unit, and to systems and methods related to such approaches.

### BACKGROUND

Heat pumps are devices that transfer heat energy from one thermal bath (typically a thermally insulated chamber) to another, accomplishing this task by drawing power from an external source. Typically, a device containing a heat pump strives to maintain a nearly constant temperature in one of the thermal baths by using a feedback control system. In the example of an air condition system, the heat pump (typically in the form of a vapor compression system) transfers heat from the interior of a building to the exterior, while maintaining the interior at a nearly fixed cold temperature. The external power source is typically the mains power supply, and the control mechanism is based on a thermostat with bang-bang control of the vapor compression pump. This disclosure describes the inference of characteristic of the environment of heat pump device components in general (with air conditioner condensers as a particular instance) based on power consumption of such devices.

The local operating environment of a refrigerant condenser unit affects its power consumption. The local operating environment has traditionally been determined by a manual in-person audit of an air conditioning system or analysis using aerial or satellite photography.

### SUMMARY

Some embodiments described herein are directed to a system configured to remotely determine characteristics of the local operating environment of a refrigerant condenser unit. The system includes a detector configured to sample power consumption of a refrigerant condenser unit to obtain a sampled power consumption time series. An analyzer receives the sampled time series of the detector and determines characteristics of a local operating environment of the condenser unit from the power consumption time series. The analyzer generates an output that includes information about the local operating environment.

According to some implementations, the detector samples power consumption of the condenser unit at a resolution sufficient to determine durations of time in which it is active (“on”) and durations of time in which it is inactive (“off”). A period when a component is on immediately followed by or preceded by a period when the component is off will be referred to as a power cycle of the component. The duty cycle of a power cycle is defined as the ratio of the time duration in which the component is on divided by the time duration from when the component turns on until the next time the component is on (or the time duration between successive off times).

The analyzer extracts the power cycles from the sampled power consumption time series and determines the characteristics of the local operating environment of the condenser unit from the power cycles. For example, the detector may sample the power consumption at a frequency of about one sample per minute or a higher frequency.

According to some implementations, the characteristics of the local operating environment include one or more of shading, temperature, humidity, air flow, and exposure of the condenser unit to weather conditions.

According to some implementations, the condenser unit is a component of an air conditioner for a facility that includes other appliances and the detector samples power consumption of the facility. The analyzer is configured to disaggregate the power cycles of the condenser unit from power cycles of the other appliances. According to other implementations, the condenser unit is a component of an air conditioner for a facility that includes other appliances and the detector samples power consumption of the condenser unit separately from the other appliances. According to some implementations, the detector samples power consumption of appliances and devices of a facility, and the power consumption and performance of these appliances and devices is affected by their operating environment.

In some implementations, the analyzer is configured to receive weather data and to use the weather data in conjunction with the sampled power consumption time series to determine the characteristics of the local operating environment. For example, the weather data may include one or more of temperature, humidity, solar irradiance, cloud cover, and wind speed.

In some implementations of the system the analyzer extracts power cycles of the condenser unit from the power consumption time series by comparing the sampled power consumption time series to a threshold. The analyzer may dynamically determine a threshold, e.g., an optimal threshold, to use for extracting the power cycles.

In determining characteristics of the local operating environment, the analyzer may determine temperature of the local operating environment based on the power consumption of the condenser unit. The analyzer may determine air flow around the condenser unit based on wind speed used in conjunction with variation in the temperature of the local operating environment of the condenser unit. Alternatively or additionally, the analyzer may determine shading of the condenser unit based on transitory decreases in the power consumption of the condenser unit as related to position of the sun and cloud cover. Alternatively or additionally, the analyzer may determine relative humidity of the local operating environment of the condenser unit based on a difference between power consumption during relatively less shaded conditions and power consumption during relatively more shaded conditions of the condenser unit.

The analyzer may be further configured to flag one or more facilities for interactions, targeted communications, maintenance, or outreach from a party that has an interest in the facility, the appliance, or the energy consumption of the facility.

Some embodiments are directed to a method of determining a local operating environment of a refrigerant condenser unit. The method involves sampling power consumption of a refrigerant condenser unit and determining characteristics of a local operating environment of the condenser unit from the power consumption. An output is generated that includes information about the characteristics of the local operating environment.

According to some implementations, the characteristics of the local operating environment include one or more of shading of the condenser unit, temperature of the condenser unit, relative humidity of the environment around the condenser unit, and air flow around the condenser unit.

According to some implementations, the method includes receiving weather data for a location in the vicinity of the operating environment from an external source and using the weather data in conjunction with the power consumption of the condenser unit to determine the characteristics of the local operating environment. For example, the weather data can include one or more of temperature, humidity (relative an/or absolute), cloud cover, solar irradiance, and wind speed.

According to some implementations, customers are sent information relating to incentives, e.g., to increase efficiency and/or lower power consumption based on the generated output.

### BRIEF DESCRIPTION OF THE DRAWINGS

FIG. 1 is a block diagram of a system in accordance with some embodiments;

FIG. 2 is a flow diagram of a method for determining characteristics of a local operating environment of a refrigerant condenser unit in accordance with some embodiments;

FIG. 3 is a graph that shows a sampled power consumption time series of a condenser unit over a period of about three days;

FIG. 4 is a graph that shows the variation in the temperature of the local operating environment of the condenser unit over the same period as FIG. 3;

FIG. 5 is a graph of the sunlight (solar irradiance) over a two day period obtained from weather data, showing peaks at approximately noon;

FIG. 6 is a graph of the envelope of power cycles over the period of FIG. 5; and

FIG. 7 is a flow diagram of a method for determining if the condenser unit is exposed to or protected from weather conditions and/or how an amount of protection provided by the environment of the condenser unit in accordance with some embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The local operating environment of a refrigerant condenser unit, such as a condenser unit of an air conditioner system, affects its power consumption. Characteristics of the local operating environment have traditionally been determined by manual inspection, such as an in-person audit of the condenser unit or inspection using aerial or satellite photography. Manual inspection is time consuming, costly, and potentially disruptive to the consumer, while aerial or satellite photography may be unavailable, out-of-date, inaccurate, and/or intrusive.

Embodiments described herein are directed to systems and methods for determining characteristics of the local operating environment of a outdoor condenser unit based on the power consumption of the condenser unit. The local operating environment is the environment within an area that affects operation of the condenser unit, e.g., within about 10 ft. of the condenser unit. The characteristics of the local operating environment may include one or more of shading of the condenser unit, local operating temperature, insolation, local humidity, airflow/ventilation of the condenser unit and/or amount of protection of the condenser unit from weather conditions. The weather conditions may include for example, the temperature, humidity, irradiance, wind speed, and/or any other conditions that are globally present near the condenser unit. For example, the weather conditions may be those available from weather data, wherein the weather data can be obtained locally from sensors or obtained from an external server. After one or more characteristics of the local operating conditions are determined, a consumer may be notified of the local operating conditions of the condenser unit and may be offered incentives to alter the local environment of the condenser unit in a way that would increase efficiency of the condenser unit and/or lower power consumption of the condenser unit.

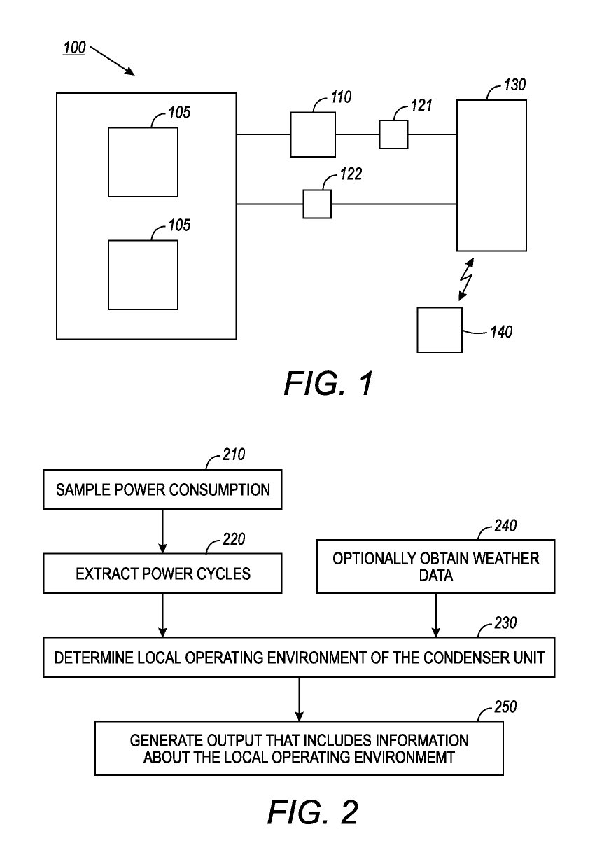

FIG. 1 is a block diagram illustrating a system 100 for determining the local operating environment of a condenser unit 110. The condenser unit 110 is located near a facility 101 that may also house other power consuming appliances 105. In some implementations, the condenser unit is the outdoor condenser unit of an air conditioner for the facility, for example. The facility 101 may be any type of facility, e.g., a private home or apartment, a business or commercial facility. One or more detectors 121, 122 can be arranged to measure power consumption of the condenser unit 110 and/or power consumption of the facility, e.g., by periodically measuring the voltage and/or current drawn by the condenser unit or facility. In some implementations, the power consumption of the condenser unit 110 may be measured separately from the power consumption of the other appliances 105 using detector 121. In other implementations, the power consumption of the condenser unit 110 and other appliances 105 of the facility 101 are measured in aggregate using detector 122. The detector 121, 122 is configured to provide a high resolution sampled power consumption time series by sampling the power consumption of the condenser unit 110 and/or the facility 101 at a frequency of about 1 sample per minute or at a higher frequency. In some embodiments, the detector 121, 122 is configured to provide a high resolution sampled power consumption time series by sampling the power consumption of the condenser unit 110 and/or facility 101 at a frequency of about 1 sample per second or at a higher frequency.

The system 100 includes an analyzer 130 configured to analyze the power consumption time series data provided by the detector 121, 122 to extract power cycles of the condenser unit 110. In implementations wherein the sampled power consumption time series includes aggregated power consumption of the condenser unit 110 and other appliances 105 of the facility 101, the analyzer 130 is configured to disaggregate the sampled power consumption time series of the condenser unit 110 from that of the other appliances 105. The analyzer 130 is configured to use the power cycles to determine the local operating environment of the condenser unit, e.g., shading, local temperature, local humidity (relative or absolute), ventilation/airflow around the condenser unit and/or exposure/protection of the condenser unit to weather conditions. In some embodiments the analyzer may be coupled through a wired or wireless communication channel to a external source, e.g., remote server 140, that provides weather data to the analyzer 130. For example, the weather data received from the server can be time stamped data that includes temperature, relative and/or absolute humidity, cloud cover, wind speed, irradiance data, etc. at a location that includes the local operating environment. Note that the weather data, e.g., temperature, humidity, in the surrounding area of the condenser unit may or may not accurately reflect the local operating environment of the condenser unit. For example, weather data does not take into account factors of the condenser unit environment, such as the placement of the condenser unit with respect to a building, shading of the condenser unit by plants and/or other structures, and/or exposure of the condenser unit to wind, sun, moisture, and/or other local operating conditions. The analyzer may optionally use the weather data in conjunction with the sampled power consumption time series to determine characteristics of the local operating environment of the condenser unit.

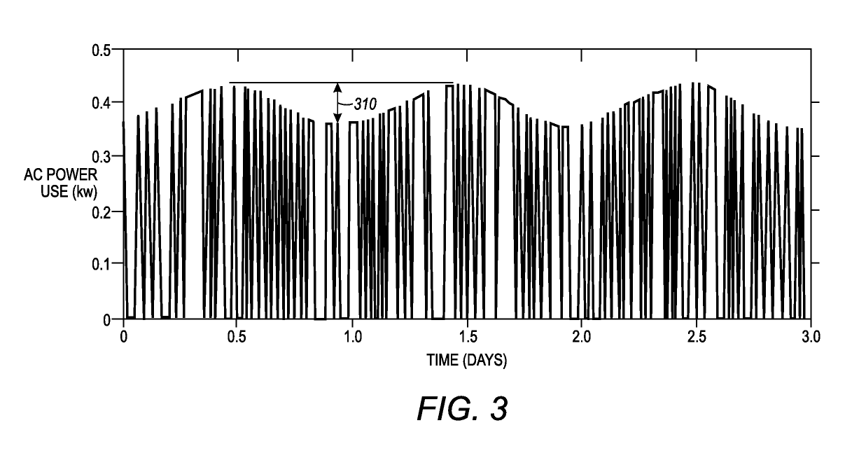

FIG. 2 is a flow diagram that illustrates operation of the system 100. The detector samples 210 power consumption of the refrigerant condenser unit of a facility. In a preferred embodiment, the method is applied to a single condenser unit, e.g., an air conditioner condenser unit, with a presumption that the condenser unit power consumption can be sampled separately from other appliance of the facility, and that the time series of the sampled power consumption is sufficiently high resolution to observe individual power cycles of the condenser unit, e.g., 1 sample per minute or a higher frequency.

If the power consumption of the facility is sampled, the power consumption, e.g., power cycles, of the condenser unit are disaggregated from the power consumption of other appliances of the facility. The analyzer may extract 220 the power cycles of the condenser unit from the sampled data. The analyzer determines 230 characteristics of the local operating environment of the condenser unit based on the power consumption of the condenser unit.

The analyzer generates 250 an output that includes information about the local operating environment of the condenser unit. Optionally, in some embodiments the analyzer may receive 240 weather data, e.g., from a remote external source, and use the weather data in conjunction with the sampled power consumption time series of the condenser unit to determine the local operating environment of the condenser unit.

In some embodiments, the analyzer may receive information from multiple facilities and identify facilities that have a condenser unit with a local operating environment that causes the efficiency and/or power consumption of the condenser unit to be sub optimal. These facilities may be targeted for communications, maintenance, or outreach to encourage consumers responsible for the facilities to alter the local operating environment of the condenser unit so that the condenser unit uses less power and/or provides more efficient power consumption. Alteration of the local operating environment of the condenser unit can involve actions such as moving the condenser unit, building an enclosure around the condenser unit, building a sun shade over the condenser unit, planting shade bushes/trees and/or other landscaping near the condenser unit, etc.

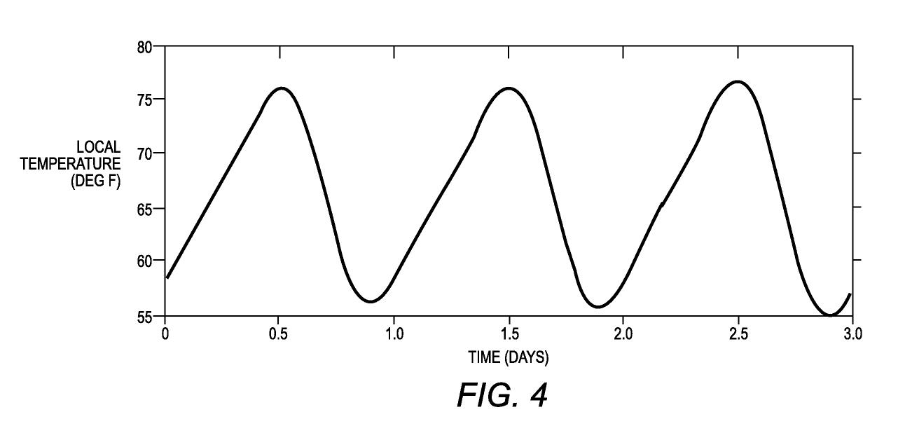

FIG. 3 is a graph that shows a sampled power consumption time series of a condenser unit over a period of about three days. The power cycles (on-off cycles) of the condenser unit are evident from the sampled power consumption time series shown in FIG. 3. FIG. 4 is a graph that shows the variation in the temperature of the local operating environment of the condenser unit over the same period. The correlation between variation in power consumption and temperature is evident from FIGS. 3 and 4 and is typical of condenser systems in vapor compression systems. The power consumption variation is approximately linear with respect to the temperature variation, and we will assume linearity of the power consumption with respect to various environmental parameters including, for example, insolation, humidity, and wind speed. This assumption is valid for small changes in the power consumption, as is typically the case. This correlation can be found in other heat pumping systems other than vapor compression systems since in general, the efficiency of the system is dependent on the characteristics of both thermal baths. In the case of most vapor compression systems, the correlation arises from the dependence of the vapor pressure on the temperature of the hot side, ultimately affecting the back pressure on the fluid pump. The magnitude of the power consumption, the depth of the variation of power consumption envelope (indicated by arrow 310) and/or other characteristics of the sampled power consumption time series can be used to determine characteristics of the local operating environment of the condenser unit as discussed in more detail below.

The power cycles of the condenser unit can be extracted from the power consumption time series by thresholding the power level of the power consumption samples against a predetermined threshold value. In some cases, the threshold value can be dynamically determined, for example by selecting a level that is half the maximum recorded power level in the recent recording history. In either case, the times the condenser is on can be determined, as well as its average power level during the cycle. The characteristics of the local operating environment typically fluctuate, and the analysis must account for the relevant time scales of these variations. In the preferred embodiment, the characteristics of the local operating environment are assumed to change on a time scale that is much longer than the duration of the power cycles so that power cycle averages are meaningful. In instances when the characteristics of the local operating environment vary rapidly with respect to the duration of power cycles, the inferred characteristics of the environment represent time-averaged parameters.

In some embodiments, the characteristics of the local operating environment of the condenser unit include local temperature in the area of the condenser unit and the analyzer is configured to determine local temperature. FIGS. 3 and 4 illustrate the variation in the power consumption in response to changes in local temperature with higher power consumption correlated to higher local temperature. The power consumption of the condenser unit is relatively higher when the local temperature is higher and the power consumption is of the condenser unit is relatively lower when the local temperature is lower. Thus, the temperature of the condenser unit (e.g., temperature relatively higher or relatively lower) can be determined from the power consumption of the condenser unit. If the temperature measurement is calibrated, e.g., using an external thermometer, or temperature information from some other source, or a detailed physical model of the condenser, then the actual temperature of the local environment can be determined based on the power consumption of the condenser unit. Since lower environment temperatures correspond to lower energy use of the condenser, the local temperature information determined in this way may be used, for example, to provide targeted communications and maintenance suggestions to the operator of the facility containing the condenser unit.

In some embodiments, the characteristics of the local operating environment of the condenser unit include local relative humidity in the area of the condenser unit and the analyzer is configured to determine local relative humidity. The power consumption of the condenser unit may be correlated to local relative humidity. In the case of an air conditioning system, higher humidity leads to an increase in the heat capacity of the air in the local operating environment, which in turn increases the latent capacity of the system. This may cause an increase in the duty cycle if the volume being cooled also experiences higher humidity. Thus, based on the correlation between local relative humidity and power consumption, if the local temperature is known, e.g., from a thermometer, approximate changes in the local relative humidity can be inferred from the power consumption variations.

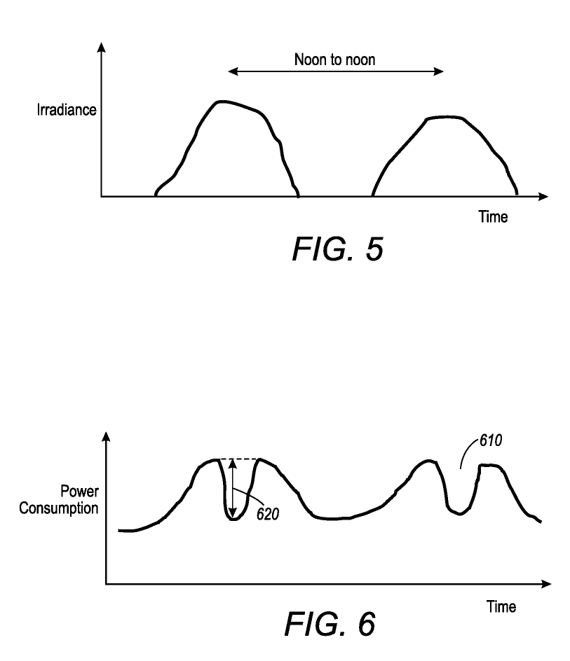

In some embodiments, the characteristics of the local operating environment of the condenser unit include shading of the condenser unit and the analyzer is configured to determine the presence and/or amount of shading. The analyzer may determine a degree of shading based on the magnitude of condenser power consumption variation throughout the day. A fully insolated condenser in a vapor compression system will have a greater degree of power variation than one that is not insolated due to the direct heating of the device and ambient air under sunlight. This in turn affects the pressure of the refrigerant within the vapor compression circuit and the power consumption as described previously. Furthermore, if the amount of shading varies throughout the day, the effect of shading can be observed as a disproportionate change in the condenser power draw with respect to the ambient temperature. In some embodiments, the presence of shading can be determined by transitory decreases in the power consumption envelope of the power cycles of the condenser unit. FIG. 5 is a graph of the sunlight (solar irradiance) over a two day period obtained from weather data, showing peaks at approximately noon. FIG. 6 is a graph of the envelope of power cycles over the period of FIG. 5. In the absence of shading, it would be expected that the power envelope of the condenser unit would track the irradiance with higher irradiance correlated to a hotter local condenser unit environment and higher power consumption. Where sharp drops 610 in the power consumption occur regularly at specific times of day the analyzer infers that the condenser unit is being shaded by some object when the sun is at particular angles in the sky. The amount of shading can be inferred by the depth 620 of the transitory decresases in power consumption 610.

According to some embodiments, the characteristics of the local operating environment of the condenser unit include airflow around the condenser unit and the analyzer is configured to determine the airflow. For example, all else being equal, if the power variation does not differ significantly between times of high and low wind, the analyzer may determine that the condenser environment is not well ventilated or is shielded from the wind. Alternatively, if the power variation does not differ significantly between times of high and low relative humidity or other confounding weather parameters, the analyzer may determine that the condenser is likely in an environment with regulated or buffered humidity.

According to some embodiments, the characteristics of the local operating environment of the condenser unit include exposure of the condenser unit to weather conditions such as sun and wind, etc. and the analyzer is configured to determine whether the condenser unit is exposed to the weather conditions and/or an amount of protection of the condenser unit from the weather conditions. Exposure to weather conditions may include exposure to wind, cloud cover, irradiance, temperature, humidity, and/or other weather conditions, for example. The analyzer can correlate weather conditions to observed parameters of the power consumption envelope of the condenser unit. For example, persistent clouds and high winds will generally produce cooler condenser units during the daytime, so the power consumption envelope is not likely to vary as much in amplitude over a day when these weather conditions are present relative to days in which temperature, cloud cover, and solar irradiance vary throughout the day. The analyzer may be configured to correlate the power consumption envelope amplitude with quantitative measures of wind speed and cloud cover to determine the degree of exposure of the condenser unit to environmental elements which provides a measure of how protected the condenser environment is, e.g., how “outdoors” the condenser environment is. For example, if there is high correlation between weather conditions (e.g., including wind and/or irradiance) and power consumption of the condenser unit, the analyzer may determine that the condenser unit is in an exposed location. If there is little correlation between the weather conditions and power consumption of the condenser unit, the analyzer may determine that the condenser unit is protected, e.g., because it is housed in an enclosure.

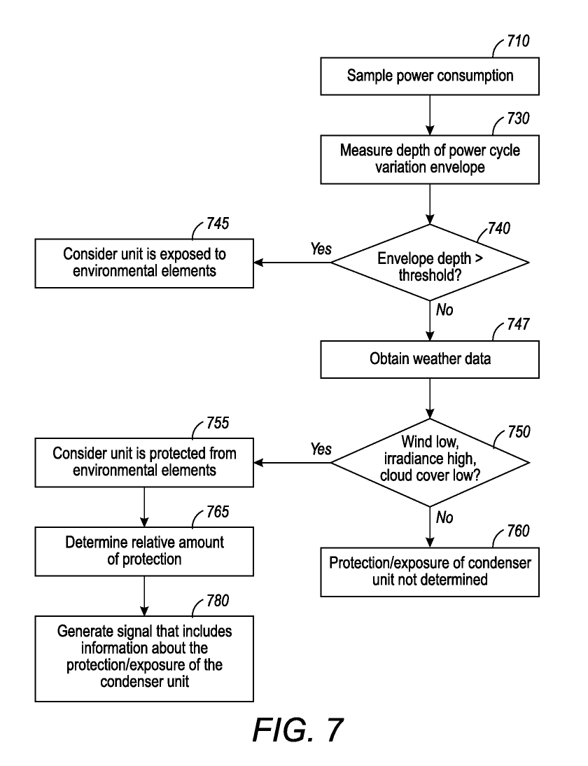

FIG. 7 is a flow diagram of a method for determining if the condenser unit is exposed to or protected from weather conditions, and/or an amount of protection provided by the environment of the condenser unit. The power consumption of the condenser unit is sampled 710 and a parameter related to the correlation of the power consumption with weather parameters is computed 730. For example, a particularly simple parameter can be determined from the magnitude and shape of variation in the power consumption envelope. When correlating against insolation, the magnitude of variation of the power consumption envelope during a single day is illustrated by element 620 of FIG. 6. If the power consumption envelope depth is greater than or equal to 740 a threshold value, this indicates that the power consumption is varying due to weather conditions and the analysis determines 745 that the condenser unit is exposed to the weather conditions. If the power consumption envelope depth is less than 740 the threshold value, the analysis determines that the condenser unit is protected from the weather conditions. In other embodiments, the cross-correlation of the power consumption and the ambient temperature obtained from weather data is used to determine the degree of protection from the weather by comparing the zero time lag value with a threshold value. Weather data can be obtained, for example, from environmental sensors and/or an external weather data server. The analysis correlates the weather data, e.g., wind, irradiance, cloud cover, etc. to the power consumption envelope. The analysis correlates 750 the weather data with the variation in power consumption envelope depth. For example if the wind is low, irradiance is high, and cloud cover is low as indicated by the weather data, a more exposed condenser unit exhibits a greater correlation value of the power envelope with irradiance than with other weather parameters. A more protected condenser unit exhibits variation lower correlation value in the envelope depth over a single day due to the diurnal temperature cycle. Thus, if the weather data indicates that the wind is low, irradiance is high and cloud cover is low and the power cycle envelope correlations are also low, the analysis determines 755 that the condenser unit is protected from the environmental elements. If the analysis indicates that wind is high, irradiance is low and cloud cover is high, and the power cycle envelope correlation values are also low, this situation is expected and the protection/exposure of the condenser unit may not be determined 760 and/or additional data may be needed to determine the protection/exposure of the condenser unit.

The analysis may determine 765 a relative degree or amount of protection of the condenser unit based on the correlation between the weather conditions and the variation of the power consumption envelope. For example, the degree or amount of protection may be expressed as a parameter value between 1 and 10 such that if the parameter value is high, this is an indication of a relatively high amount of protection from the weather conditions and if the parameter value is low it indicates a relatively low amount of protection from the weather conditions. The analyzer may generate 780 a signal that includes information about whether the condenser unit is protected from certain weather conditions, (e.g., 1=exposed to sunlight, 0=shaded) and/or an amount of protection from the weather conditions, e.g., value from 1 to 10 that indicates an amount of protection). Alternatively, this analysis may evaluate multiple facilities only on a comparative basis without determining an absolute degree of protection from weather conditions for each facility. For example, based on a comparative analysis, the analyser may determine that one facility contains a condenser more protected from the weather than another facility.

Based on the analysis of the local operating environment of the condenser unit, a utility with data on multiple condenser units can select from these analyses a group of consumers or facility operators to receive incentives, instructions, suggestions, and more generally, communications, related to reducing energy consumption, e.g., air conditioning energy consumption, by adding shielding from the sun. For example, this may be in the form of planting trees or constructing awnings. After offering such incentives, the same analysis used to identify the targeted facilities could be used to evaluate the effectiveness of the energy efficiency programs.

The approaches discussed herein can be used to make a broad comparison of the local operating environments of condenser units without the time and expense of a manual inspection. Furthermore, the approaches allow for continuous long-term monitoring of such environments, allowing the recommendation of maintenance. The approaches disclosed herein provide the ability to compare different units. The relative values provided by this comparison can be of great value even in cases where quantitative accuracy is lower. The approaches discussed above may not be as accurate as going to the facility and surveying the environment, however, the cost/benefit ratio of the disclosed approaches is superior because of the information that is obtainable at reduced cost. The approaches discussed herein are not limited to external (outdoor) condenser units. Interior condenser units may also be analyzed in a similar fashion. For example the ambient temperature variations of a condenser enclosed in a room may be determined from the methods described previously. In these cases direct insolation and/or other external weather conditions are not expected to have a major effect on the power consumption of the condenser unit if it is completely enclosed in a room or other controlled environment.

Air conditioning and/or other vapor compression systems operating in controlled or extreme environments may be monitored this way to provide a simple non-intrusive measurement of such environments.

Characteristics of the local operating environment of a condenser unit, e.g., an air conditioner condenser, can be determined from power consumption data without requiring additional measurement apparatus or manual inspections. The characteristics of the local operating environment can include, for example, local temperature over time, local relative humidity over time, relative shading from insolation, airflow around the condenser unit, amount of exposure of the condenser unit to weather conditions. The analysis goes beyond the simple question of which air conditioners use more energy, and attempts to provide a reason for higher air conditioner energy usage due to the dependence of condenser power consumption on its ambient operating environment. Inferences about the local operating environment of a condenser unit can be used to targeting incentive programs that recommend modifications of the condenser environment to improve energy efficiency. More generally, these inferences allow for indirect measurement of local operating environment characteristics in situations in which it would be inconvenient or impossible to perform a direct measurement.

Approaches discussed herein involve methods and systems for remotely determining characteristics of air conditioner condenser local environments. The characteristics can be determined from high resolution power use data from either disaggregation from power consumption data obtained from facility power line or a dedicated power consumption monitor. High resolution means that the individual power cycles of the compressor can be clearly resolved (e.g., about 1 minute resolution). The characteristics of the local operating environment of the condenser unit may include local temperature, insolation, and wind speed or air flow, for example. These characteristics may be obtained continuously over time. According to some aspects, energy efficiency programs can be targeted to consumers based on these characteristics. The energy efficiency programs may include one or more of providing incentives to improve condenser shading (e.g. by constructing shades or planting trees, providing incentives to improve condenser ventilation, and/or other such targeted communications.

The analyzer may be implemented as a processor or circuit configured to implement the processes outlined by the flow diagrams discussed herein. The detector and/or analyzer described herein may be implemented in hardware or by any combination of hardware, software and/or firmware. For example, in some embodiments, all or part of the analyzer may be implemented in hardware. In some embodiments, the analyzer may be implemented by a microcontroller implementing software instructions stored in a computer readable medium.

The foregoing description of various embodiments has been presented for the purposes of illustration and description and not limitation. The embodiments disclosed are not intended to be exhaustive or to limit the possible implementations to the embodiments disclosed. Many modifications and variations are possible in light of the above teaching.

1. A system comprising:
a detector configured to sample power consumption of a refrigerant condenser unit to obtain a sampled power consumption time series; and
an analyzer configured to determine characteristics of a local operating environment of the condenser unit from the power consumption time series, the analyzer further configured to generate an output that includes information about the local operating environment.

2. The system of claim 1, wherein:
the detector is configured to sample power consumption of the condenser unit at a resolution sufficient to extract individual power cycles of the condenser unit; and
the analyzer is configured to extract the power cycles from the sampled power consumption time series and to determine characteristics of the local operating environment of the condenser unit from the power cycles.

3. The system of claim 1, wherein the characteristics of the local operating environment include one or more of shading, temperature, humidity, air flow, and exposure of the condenser unit to weather conditions.

4. The system of claim 1, wherein the detector is configured to sample the power consumption at a sufficiently high frequency to accurately resolve the on-time of a cycle.

5. The system of claim 1, wherein:
the condenser unit is a component of an air conditioner for a facility that includes other appliances;
the detector is arranged to sample power consumption of the facility; and
the analyzer is configured to disaggregate the power cycles of the condenser unit from power cycles of the other appliances.

6. The system of claim 1, wherein:
the condenser unit is a component of an air conditioner for a facility that includes other appliances; and
the detector is arranged to sample power consumption of the condenser unit separately from the other appliances.

7. The system of claim 1, wherein the analyzer is configured to receive weather data and to use the weather data in conjunction with the sampled power consumption time series to determine the characteristics of the local operating environment.

8. The system of claim 7, wherein the weather data includes one or more of temperature, humidity, solar irradiance, cloud cover, and wind speed at specific points in time at the location including the local operating environment.

9. The system of claim 1, wherein the analyzer is configured to extract the power cycles of the condenser unit from the power consumption time series by comparing the sampled power consumption time series to a threshold.

10. The system of claim 9, wherein the analyzer is configured to dynamically determine the threshold.

11. The system of claim 1, wherein the analyzer is configured to determine temperature of the local operating environment based on the power consumption of the condenser unit.

12. The system of claim 11, wherein the analyzer is configured to determine air flow around the condenser unit based on wind speed obtained from an external source used in conjunction with variation in the temperature of the local operating environment of the condenser unit.

13. The system of claim 1, wherein the analyzer is configured to determine shading of the condenser unit based on transitory decreases in the power consumption of the condenser unit that are uncorrelated with an expected degree of insolation based on externally available weather data.

14. The system of claim 13, wherein the analyzer is configured to determine the humidity of the local operating environment of the condenser unit based on a difference between power consumption during relatively less shaded conditions and power consumption during relatively more shaded conditions of the condenser unit.

15. The system of claim 1, wherein the analyzer is further configured to flag a facility for targeting outreach and/or communication based on the output.

16. A method, comprising:
sampling power consumption of a refrigerant condenser unit;
determining characteristics of a local operating environment of the condenser unit from the power consumption; and
generating an output that includes information about the characteristics of the local operating environment.

17. The method of claim 16, wherein the characteristics of the local operating environment include one or more of shading of the condenser unit, temperature of the condenser unit, relative humidity of the condenser unit, and air flow around the condenser unit.

18. The method of claim 16, further comprising:
receiving weather data from an external server; and
using the weather data in conjunction with the power consumption of the condenser unit to determine the characteristics of the local operating environment.

19. The method of claim 18, wherein the weather data includes one or more of temperature, humidity, cloud cover, solar irradiance, and wind speed.

20. The method of claim 16, further comprising targeting consumers and/or facility operators for incentives, communications, or other marketing opportunities based on the output.
